(19) United States
(12) Patent Application Publication
(10) Pub. No.: US 2009/0127755 A1
(43) Pub. Date: May 21, 2009

(54) PROCESS FOR THE PRODUCTION OF A WEAR LINING FROM A PARTICULATE REFRACTORY MATERIAL FOR CASTING LADLES AND POURING BOXES, TOGETHER WITH THE WEAR LINING MADE IN THIS WAY

(75) Inventors: Steinar Slagnes, Aheim (NO); Anton Sekkingstad, Aheim (NO); Odd Westeras, Aheim (NO)

Correspondence Address: CONNOLLY BOVE LODGE & HUTZ LLP, 1875 EYE STREET, N.W., SUITE 1100, WASHINGTON, DC, 20006, US

(73) Assignee: North Cape Minerials AS

(21) Appl. No.: 12/092,492

(22) PCT Filed: Oct. 31, 2006
(86) PCT No.: PCT/IB06/03090

§ 371 Date: Sep. 11, 2008

(30) Foreign Application Priority Data
Nov. 3, 2005 (SE) 0502433-6

(51) Int. Cl. C21B 7/06; B05D 7/22

(52) U.S. Cl. 266/280; 427/230

(57) ABSTRACT

The present invention relates to a process for making a wear lining for casting ladles and pouring boxes used in foundries, in which process the wear lining is formed by introducing into a casting ladle or pouring box a pourable mass consisting of a granular or particulate refractory material that has a low heat conductivity and contains at least 4 wt-% of sodium silicate or potassium silicate and which binds together to form a solid mass in situ by means of a silica-containing gel precipitated from the silicate by the addition of a suitable ester or mixture of esters, optionally combined with the introduction of carbon dioxide. The invention also relates to a process for increasing the service life of the wear lining made in this way by adapting its MgO content according to whether it—the lining—comes into contact mainly with molten metal or molten slag.

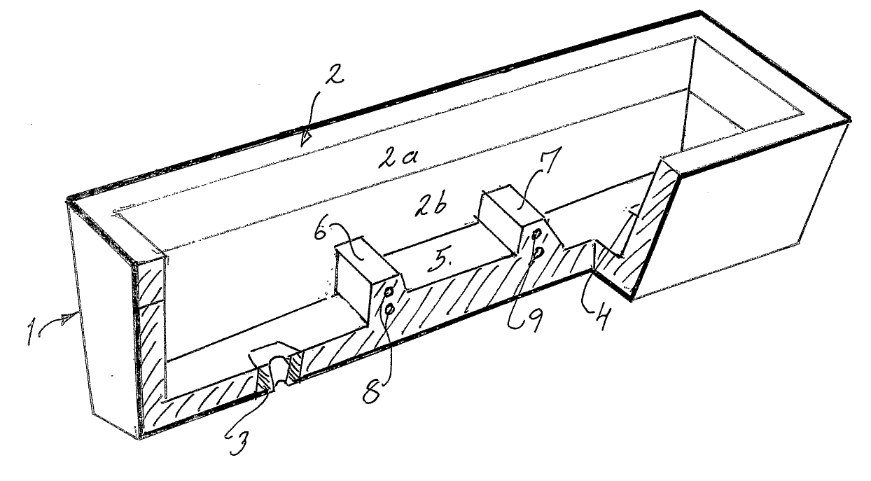

### TECHNICAL FIELD OF THE INVENTION

The present invention relates to the further development of the subject of Swedish Patent Application 0,402,192-9 (WO 2006/030,319), namely a process for the production of a refractory wear lining for casting ladles and pouring boxes, using potassium silicate or sodium silicate as a binder for particulate refractory materials whose properties make them suitable for use as basic constituents of such refractory wear linings.

More specifically, the present invention relates to a process for the production of a wear lining for casting ladles or pouring boxes for use in foundries, in which process a pourable mass is introduced e.g. into the gap between a mould inserted into the casting ladle or pouring box and its more permanent lining, where the pourable mass consists of a granular or particulate refractory material that has a low heat conductivity and contains a binder in the form of at least 4 wt-% of sodium silicate or potassium silicate and an ester or a mixture of esters, this binder being capable of converting the said silicate into a silica-containing gel, which binds the particulate refractory material into a solid substance.

The invention also relates to a wear lining made by the above process.

### PRIOR ART AND THE PROBLEM TO BE SOLVED

The term “casting ladle” used here denotes both the very large foundry ladles used in steel-making and other branches of metallurgy for the manufacture of various foundry products e.g. by continuous casting, and the much smaller casting ladles also used in the foundry sector. The term “pouring box” is used here to denote the pony ladles or tun dishes and the distribution vessels customarily employed in continuous casting plants, which give rise to a number of strands.

As the name suggests, a wear lining is that part of the lining of a casting ladle or pouring box which is consumed during use and must therefore be renewed at regular intervals. Consequently, the time and work involved in its replacement are critical for the economic aspect of the operation.

The usual practice with this type of wear lining of casting ladles and pouring boxes has so far been either to apply—over their more resistant, protective lining—fitted slabs of a refractory material, attached by masonry work, or to apply a hardening mass or mix of a granular refractory material by spraying, stamping or some another method.

The hardening agent or binder present in such a spraying or stamping mix used nowadays in industry is generally an organic binder, such as a phenol/formaldehyde, resin or a urea/formaldehyde resin, but some inorganic binders have also been employed. As far as it is known, no one has so far succeeded in showing that the phenol resins, which are the most often used binders in this field, are detrimental to health, but according to some reports they do cause e.g. indisposition in the operators handling them. In addition, the phenol resins left behind after use cannot be disposed of simply as ordinary waste like sand according to the current environmental regulations and must instead be dumped on rubbish tips by mixing them with some organic waste such as household rubbish, which helps to decompose the residual phenols in them.

There are therefore even some environmental reasons for trying to find a new binder for the particulate refractory materials used nowadays in foundries to produce a wear lining for casting ladles and pouring boxes.

Numerous different refractory materials with a low heat conductivity have so far been used for the lining of casting ladles and pouring boxes in the form of the above-mentioned prefabricated slabs or blocks and as particulate materials, forming the main components of the hardening particulate mixes mentioned above. The same particulate refractory mixes can be used as the main components of the wear lining according to the present invention. The type of refractory material used in any given case for making a wear lining according to the present invention depends to a large extent on the type of molten metal handled in the lined casting ladles or pouring boxes lined with it in the foundry.

Suitable particulate refractory materials of this kind include e.g. silica (silicon dioxide), magnesite (magnesium carbonate), alumina (aluminium oxide), aluminium silicates (e.g. fireclay), magnesium silicates (e.g. olivine) and carbonaceous refractory materials (e.g. crushed coke and blast furnace slag). It has also been known to admix to such heat-resistant lining materials smaller amounts of an inorganic fibrous material or sawdust, which is burned to form a gas when the finished product, i.e. the lining, comes into contact with the molten metal, so that pores are formed in it, which reduces the heat conductivity of the finished lining.

According to the present Applicant's Swedish Patent Application No. 0,402,192-9 mentioned above, one does not employ either the phenol resins which are so often used nowadays or the other hardening agents employed for the same purpose after moulding a heat-resistant granular material, but instead binds the latter by admixing to it already at the start a small amount of sodium silicate or potassium silicate, which is reacted with carbon dioxide introduced after the mass has been moulded. The fact is that these silicates react with carbon dioxide to form a silica-containing gel, which rapidly binds the granular main component to form a finished lining that is tough, strong and adheres well to the protective lining already in place. As proposed in the above Swedish Patent Application, the binder used here can be either sodium silicate or potassium silicate, both of which may be denoted by the term “waterglass”. The amount of sodium silicate or potassium silicate added is generally more than 4% and preferably 6-12%, which ensures—after the introduction of carbon dioxide—the formation of a sufficient amount of silica-containing gel for the required binding of the composite particulate base material in the way proposed here.

The basic technique for binding a particulate refractory material by admixing a small amount of sodium silicate or potassium silicate, which is reacted with carbon dioxide after moulding the mass—is the same as the one that has so far been employed in foundry practice mainly for making casting ladles and moulds but also for the lining of hot tops. This technique is described in Swedish Patent Application No. 4837, dating back to 1956.

It may be thought obvious to borrow the technique used for hot tops and apply it to casting ladles and pouring boxes, but in fact this seems not to have been done so far, although the carbon dioxide method has been known in foundry practice at least since the 1950's. This must be taken as an indication that this technology transfer is by no means obvious to the expert working in this field.

French Patent No. 2,732,915 discloses a process for making a wear lining for continuous casting plants, in which an outer wear layer is formed by sodium silicate hardened with carbon dioxide, and a layer of unhardened porous material is applied inside it. The aim here is evidently to use the unhardened layer as a thermal insulator and ensure a sufficient permeability for the lining.

However, the mechanical strength of such a lining with a completely unhardened inside layer is bound to be less satisfactory and therefore seems to represent a risk that is quite unnecessary, since it has already been found possible to achieve a homogeneous lining that has both the required thermal insulating ability and the required permeability by suitably choosing the particle size for the main particulate component of the lining material.

The basic teaching of the present Applicant's original Swedish Patent Application No. 0,402,192-9 (WO 2006/030,319) is therefore to utilize the “silicate method” for producing a wear lining for casting ladles and pouring boxes, in which process the wear lining of these casting ladles and pouring boxes is formed by inserting a pourable mass of a particulate refractory material between their more permanent lining and the fixture inserted in them, where the said mass comprises at least 4% and preferably 6-12% of sodium silicate or potassium silicate, and carbon dioxide is introduced into it in situ in a sufficient amount to bind the silicate additive into a silica-containing gel, which in turn binds the bulk of the particulate refractory material in the lining to form a firmly cohesive body.

However, it has since been found equally possible to harden a sodium silicate or potassium silicate binder to form the required silica-containing gel without the addition of carbon dioxide, and specifically by the addition of a suitable ester to the silicate-containing particulate base. It is of course well known that sodium and potassium (Na/K) silicate can be hardened with an ester, but as far as can be ascertained it is definitely a novel idea to use this hardening method for making such large objects as the wear linings of casting ladles and pouring boxes.

The basis of the ester-based hardening of a silicate-containing particulate mass is that, in the presence of water, the ester is split into an acid and an alcohol, which in turn causes the Na/K silicate to gel, and this gel binds the particulate mass, with the elimination of water. The rate of hardening of the Na/K silicate-containing mass, brought about the addition of an ester, can be regulated by the choice of the ester used. The ester, which is suitably added to the particulate base immediately before the addition of the Na/K silicate, should be incorporated in an amount of 10-12%, calculated on the weight of the Na/K silicate, which should in turn represent at least 3.5-4.5% of the material.

Numerous different esters can be used for hardening Na/K silicates, giving different rates of hardening. It is sufficient to name here as examples only those esters which have already been used for hardening Na/K silicates in casting moulds and casting ladles and which have relatively well-known silicate hardening and other properties in this application, the esters in question being glycerol monoacetate (1,2,3-propanetriol monoacetate), glycerol diacetate (1,2,3-propanetriol diacetate) and glycerol triacetate (1,2,3-propanetriol triacetate).

The hardening rate of Na/K silicate can be regulated not only by the choice of the ester added, but also by mixing different esters together to ensure the required hardening time.

As mentioned above, water is formed when the Na/K silicate is hardened with an ester, so the water must be allowed to escape after the hardening reaction, otherwise it will stagnate there. Owing to the presence of this water, the ester-hardened silicate-containing mass generally develops a well-hardened outside layer, since the water formed in the hardening reaction is allowed to escape there, while the deeper-lying areas of the mass tend to have a lower mechanical strength, owing to the greater residual moisture content prevailing there.

It might therefore be thought better to use carbon dioxide to harden such large objects as the lining of casting ladles and pouring boxes envisaged here. However, this involves two problems, one is due to the fact that it is difficult to achieve a uniform gas penetration in large objects, and the other problem is due to the fact that, as careful experiments have clearly shown, an insufficient CO₂ input gives a poorly hardened mass, while an excess CO₂ input gives rise to a reduced mechanical strength in comparison with that of the mass obtained with the right amount of CO₂. It can therefore be a problem to adjust the latter to the correct level.

In a further development of the present invention, the CO₂-based hardening of Na/K silicate is combined with its ester-based hardening. In this case, the ester is suitably added to the particulate base immediately before the introduction of the Na/K silicate. This gives a hardening time that can be fixed in advance, provided that the ester and the Na/K silicate are added uniformly to the whole particulate material in the course of time and reach all parts of it, and the lining made from it, more or less simultaneously. The carbon dioxide can be introduced into the more permeable parts of the lining to accelerate or reinforce the gelling process in these parts of the lining. This combined hardening process can also be applied in such a way that ester-based hardening is used in certain parts of the lining, while CO₂-based hardening is applied in other parts of it. It is possible to use a computerized control system in conjunction with a specially designed screw conveyor for mixing and feeding the ester and the Na/K silicate to the particulate base. In such a case, the delivery of the particulate base material to its envisaged site in the casting ladle or pouring box is free from the problems caused by variations or breakdowns, as well as by the need to re-start the introduction of the ester to the base material. The Na/K silicate should of course always be fed in, but a change in the composition of the base material occurring during the operation may call for a change in the percentage of the Na/K silicate in order to obtain a lining with the best properties.

In a further development of the present invention, the Na/K silicate added can be in powder form (“dry waterglass”), but then water is also needed, which can come e.g. from the moist particulate base material.

As mentioned before, such Na/K silicates have long been used as binders for the wear lining of foundry moulds and casting ladles. In this connection, the different properties of the various Na/K silicates available on the market are well known and the accumulated data about these silicates can be usefully employed when testing the silicate-containing lining proposed in this invention for casting ladles and pouring boxes. It is particularly the viscosity of the various Na/K silicate grades that is of interest here.

When using a mix hardened with Na/K silicate and applied for making foundry moulds and mould cores, experts have sometimes complained that the unhardened starting material is not very pourable, so that it is difficult to produce sufficiently fine details on the castings made in the finished moulds. However, this is less of a problem when making a lining in casting ladles and pouring boxes, because these objects of course do not have any fine details by definition. Despite this, it may be desirable in some cases to add a conventional flow-improving agent to the Na/K silicate additive to ensure that it has the required viscosity for the purpose in mind and so guarantee that the Na/K silicate is uniformly mixed with the particulate base material.

It is also known from the use of Na/K silicate binders in casting moulds and mould cores that their environmental disposal properties can be improved by the addition of a decomposing agent in the form of a sugar or very simply a raw product like molasses. This is because, when heated to a high temperature for a certain time and then cooled, a mass hardened with the aid of an Na/K silicate to which a suitable decomposing agent of this type has been added in an amount of up to 10%, calculated on the Na/K silicate content, becomes brittle. This feature can now also be utilized in the case of casting ladles and pouring boxes according to a further development of the present invention, since it is of interest in this field too to dispose of a wear lining as soon as possible after it has come to the end of its service life and needs replacing.

After transferring the general Na/K silicate hardening process from its original field of application to casting moulds and their mould cores to the production of wear linings in casting ladles and pouring boxes, it became possible to make several useful observations, leading to further inventions.

For example, it has been found that the general Na/K silicate hardening process, whether carried out with carbon dioxide or an ester, provides exceptional possibilities for the production of a lining for casting ladles and pouring boxes whose various parts are adapted to match the degree of aggressiveness of the molten metal and slag to the lining of the vessel. It is of course well known in foundry practice that the slag floating on the molten metal is always more aggressive to its surroundings than the pure molten metal is under it. Since a resistant material generally tends to be more expensive than one with a lower resistance, large savings can be achieved by adapting the resistance of the lining to the aggressiveness of the material to which the lining is primarily exposed. Such an adaptation of the resistance of the lining to the material to which it is mainly exposed also has the advantage that the whole lining is subject to a more even wear and tear and can therefore be replaced together at the same time.

It is well known for example that, of the previously mentioned refractory materials used for the lining of casting ladles and pouring boxes in steel-making, those which have a high magnesia (MgO) content exhibit a considerably higher resistance to aggressive steel slag than those with a lower magnesia content. At the same time, however, a high magnesia content of the particulate refractory material used as a starting material automatically increases the price. According to the present embodiment of the invention, it is therefore proposed to use a silicate-hardened particulate refractory lining material with a magnesia content that does not greatly exceed 45-48% in the bottom of the in casting ladles and pouring boxes and in their lower parts which predominantly come into contact with the pure molten metal, while giving their parts that are largely in contact with the much more aggressive slag a lining that is basically the same type but has a magnesia content in excess of 45%, and whenever possible one that consists of pure magnesia.

It has of course been suggested before to make a stratified lining basically of this type, but it always seems to have concerned the use of a more resistant material near the molten metal and the slag, and either a cheaper material or one with different properties (e.g. excellent insulating properties) for use inside, as proposed e.g. in French Patent No. 2,338,100 mentioned before. In these older stratified linings, the layers therefore ran vertically in the walls of the vessels. What is proposed in the present invention, by contrast, is a horizontal stratification or division of the lining in the side walls of casting ladles and pouring boxes, and more specifically the use of a material with a lower magnesia content and therefore a lower price below the normal bath level of the pure molten metal, and a material with a higher magnesia content above the normal bath level of the molten metal, i.e. in the region where the lining is mostly in contact with the much more aggressive slag. The bottom can always be made here of the material with the lower magnesium content.

The basic principle of the process according to the invention for making such a lining for casting ladles and pouring boxes is that the whole lining is built up of a Na/K silica-containing particulate refractory material that is hardened with carbon dioxide and/or an ester to form a solid body. This makes it possible to use a computerized mixer that delivers the Na/K silicate and possibly the ester to the particulate base material in such a way as to change the composition of the particulate base material, e.g. to effect a gradual transition from a lower magnesia content to a higher one for sites near the normal position of the slag layer floating on the molten metal.

An important advantage of building up the wear lining for casting ladles and pouring boxes using a particulate material initially applied in lose form that hardens and binds in situ is that it makes it possible to effect a gradual transition between the different characteristics, based on a change of the composition and/or particle size of the material.

The particulate base material primarily used according to the present invention generally has a particle size of 0.1-1 mm, but it can be varied within this range e.g. to control the gas permeability and the insulating properties of the finished lining, as well as the amount of the Na/K silicate binder required.

It is therefore possible to vary the gas permeability and the insulating properties of the finished lining within fairly wide limits through a limited change in the particle size and particle composition of the base material. Furthermore, since the various refractory base materials require different amounts of a binder, it is necessary to control the amount of the Na/K silicate and also the amount of the ester added, since ester-based hardening is used within fairly narrow limits, and—as mentioned before—it is suitably carried out with the aid of a computer-controlled screw conveyor used for mixing, or with the aid of another type of mixer used for feeding the binder to the base material and for the simultaneous delivery of the base material to the required site in the lining. As regards the need to control the addition of the binder components within narrow limits, it should be borne in mind that pure olivine requires much less binder than e.g. magnesite.

The general properties of the lining made according to the present invention may also vary with the particle size of the base material, and various particulate refractory materials may need different amounts of binder in the form of a silica-containing gel precipitated out of the Na/K silicate used, so that the computer-controlled mixing equipment also enables one to produce a lining with the best properties.

As mentioned before, the particulate refractory base material primarily used according to the present invention has a particle size comprised in the range of 0.1-1 mm. Suitable base materials are currently available commercially with particle sizes in the following ranges: 0.2-1 mm, 0.1-0.5 mm and 0.1-0.3 mm. The suitable mixing of these grades can easily give a base material with a particle size in the range of 0.1-1 mm. If this operation is combined with the use of the above-mentioned computer-controlled mixer, with which the percentages of all the components it feeds in and blends can be varied within very wide limits, it is also possible to change both the base material and the binder continuously and gradually, as well as to harden all the parts of the wear lining made according to the invention, so that the specific needs of the various parts of the lining are satisfied.

This can be very useful, since it also makes it possible to obtain a wear lining according to the invention that has optimum properties in all its parts. Thus, a base material with a smaller particle size gives a denser and more resistant lining material. However, more binder is needed here, because the total contact surface area between the particles is larger here. By contrast, a base material consisting of coarser particles needs less binder on the same grounds, i.e. a smaller total contact surface area, and it can be expected to have a somewhat lower resistance; however, the greater gas permeability ensures a better thermal insulation in the lining material.

The lining made from a particulate material and hardened in situ must be stamped or rammed on before hardening, because otherwise cavities will readily form in the hardened mass. In comparison with the production of a lining by assembling ready-made components on the spot, there is thus an extra production stage here, but one can benefit from all the advantages mentioned above, of which flexibility is perhaps the one that ensures the greatest direct gain.

This flexibility can be used e.g. to make an extra thick lining in the impact zone of the pouring boxes in question. i.e. in the region where new molten metal is introduced into them. It can also be used to form “pillars” for the dams that surround the outlet apertures or tapping holes in the customary pouring boxes in order to stop the slag from reaching these orifices when the pouring box is being emptied. The possibility to control the thickness of the lining via its introduction in the form of a particulate material also enables one to incorporate fixtures or reinforcements in the lining where these are needed, e.g. in the dam pillars mentioned above.

Finally, the lining material that has been set with the aid of a Na/K binder can also be employed according to the invention in order to replace the conventional stamping clay around the replaceable outlet nozzles in the bottom of the casting ladles and pouring boxes, these nozzles being made of an extremely resistant material.

### AIM AND CHARACTERISTICS OF THE INVENTION

An important aim of the present invention is to provide an improved process for making a wear lining for casting ladles and pouring boxes in foundries, which process eliminates or at least greatly reduces the problems described above.

This aim, as well as others not listed here, are satisfactorily achieved in the way set out in the independent claims, while various embodiments of the invention are described in the dependent claims.

The present invention thus provides an improved process for the production of a wear lining for casting ladles and pouring boxes used in foundries, characterized in that the binder is in the form of sodium or potassium silicate and an ester, which are added to the particulate refractory material simultaneously with the delivery of this material to the position where the lining is to be formed.

The other aspects of the process according to the invention are described below.

The components of the binder, i.e. sodium or potassium silicate and an ester, are added to the particulate refractory material in a combined mixing and feeding equipment, such as a conveyor screw, which is also used for mixing and conveying the particulate base material to the required position where the lining is to be formed, and the said addition is effected simultaneously with the delivery of the particulate base material to the required position.

The gas permeability and the insulating properties of the finished lining are regulated by controlling the porosity of the mixture, which in turn is achieved by regulating the particle size and particle composition of the base material with the aid of a mixing and feeding device.

The amounts of the binder components added to the particulate refractory base material in the mixing and feeding device are regulated according to the type of the particulate base material and its requirement for a binder, as well as according to its particle size and particle composition.

The lining is designed with a horizontal dividing plane that is considered to mark the top of the molten iron or steel layer and the bottom of the slag layer floating on the metal in the casting ladles and pouring boxes used in practice. The chemical composition of the granular base material used for making the lining is chosen in such a way that the finished lining has a lower total magnesia content in this part of the casting ladle or pouring box, and a higher magnesia content above this line. More specifically, the chemical composition of the base material in those parts of the lining which lie above this level (i.e. the parts that are largely expected to come in contact with the slag), exhibits a magnesia content of at least 45%.

The sodium or potassium silicate is a “dry waterglass”, which is admixed in powder form to a moist base material.

The present invention is further specified in the claims and illustrated in the attached drawing as regards the horizontal division of the lining into parts with different resistances to molten metal and slag, which differ in aggressiveness, and as regards the reinforced tapping zone, the dam and the armoured dam surrounds.

### DETAILED DESCRIPTION OF A PREFERRED EMBODIMENT

The attached drawing shows a partial cross-section of a pouring box 1 with a lining 2 made according to the process of the invention. This lining is divided into an upper part or layer 2a, which has the highest possible magnesia content and so extra resistance to withstand the aggressive action of the slag, and a lower part or layer 2b, which contains less than 45-48% of magnesia and is destined to come into contact with the much less aggressive molten metal normally contained in that region. The transition between the two horizontal lining layers 2a and 2b can be either sudden or gradual, according to the user's choice. The pouring box 1 also has outlet orifices 3 and 4 at the bottom, with corresponding nozzles embedded in layer 2b of the lining, where the outlet orifice 4 is only partly shown in the drawing. The pouring box 1 also has an impact zone 5 with an extra thick lining. The two dam pillars 6 and 7 situated on either side of the impact zone 5 have two incorporated armatures 8 and 9.

1. Process for the production of a wear lining for casting ladles and pouring boxes used in foundry practice by introducing—e.g. in the gap between a mould inserted into the casting ladle or pouring box and its more permanent lining—a pourable mass consisting of a granular or particulate refractory material that has a low heat conductivity and contains a binder in the form of at least 4 wt-% of sodium silicate or potassium silicate and an ester or a mixture of esters capable of converting the said silicate into a silica-containing gel that binds the particulate refractory material into a solid substance, characterized in that the binder consisting of the said silicate and ester is added to the particulate refractory material simultaneously with the delivery of the latter to the required position to be lined.

2. Process according to claim 1, characterized in that the binder components, sodium or potassium silicate and an ester, are added to the particulate refractory material with the aid of a combined mixing and feeding device, such as a mixing screw, which is also used to deliver the particulate base material to the required position to be lined, and in that this addition is made simultaneously with the delivery of the particulate base material to the required position.

3. Process according to claim 2, characterized in that the gas permeability and insulating properties of the finished lining are controlled via the porosity of the mixture, which is in turn regulated by adjusting the particle size and particle composition of the base material delivered with the aid of a mixing and feeding device.

4. Process according to claim 2, characterized in that the amounts of the binder components added to the particulate refractory base material with the aid of the mixing and feeding device are regulated according to the type of the particulate base material and its requirement for a binder, as well as according to its particle size and particle composition.

5. Process for the production of a wear lining for casting ladles and pouring boxes used in iron and steel foundries, in which the heat-resistant granular base material is hardened with the aid of sodium silicate or potassium silicate according to claim 1, characterized in that the chemical composition of the granular base material used for making the lining with a horizontal dividing plane that is considered to mark the top level of the molten iron or steel and the bottom level of the slag floating on the metal in the usual casting ladles or pouring boxes is chosen in such a way that the finished lining in this part of the casting ladle or pouring box has a lower total MgO content than the MgQ content above this level, while the chemical composition of the base material in the parts of the lining that lie above this level and is mostly expected to come into contact with the slag has a MgO content of at least 45%.

6. Process according to claim 1, characterized in that the silica component is used as a “dry waterglass”, which is added as a powder to the moist base material.

7. Wear lining for casting ladles and pouring boxes used in foundry practice, prepared by the process described in claim 1.

8. Process according to claim 3, characterized in that the amounts of the binder components added to the particulate refractory base material with the aid of the mixing and feeding device are regulated according to the type of the particulate base material and its requirement for a binder, as well as according to its particle size and particle composition.

9. Process for the production of a wear lining for casting ladles and pouring boxes used in iron and steel foundries, in which the heat-resistant granular base material is hardened with the aid of sodium silicate or potassium silicate according to claim 2, characterized in that the chemical composition of the granular base material used for making the lining with a horizontal dividing plane that is considered to mark the top level of the molten iron or steel and the bottom level of the slag floating on the metal in the usual casting ladles or pouring boxes is chosen in such a way that the finished lining in this part of the casting ladle or pouring box has a lower total MgO content than the MgQ content above this level, while the chemical composition of the base material in the parts of the lining that lie above this level and is mostly expected to come into contact with the slag has a MgO content of at least 45%.

10. Process for the production of a wear lining for casting ladles and pouring boxes used in iron and steel foundries, in which the heat-resistant granular base material is hardened with the aid of sodium silicate or potassium silicate according to claim 3, characterized in that the chemical composition of the granular base material used for making the lining with a horizontal dividing plane that is considered to mark the top level of the molten iron or steel and the bottom level of the slag floating on the metal in the usual casting ladles or pouring boxes is chosen in such a way that the finished lining in this part of the casting ladle or pouring box has a lower total MgO content than the MgQ content above this level, while the chemical composition of the base material in the parts of the lining that lie above this level and is mostly expected to come into contact with the slag has a MgO content of at least 45%.

11. Process for the production of a wear lining for casting ladles and pouring boxes used in iron and steel foundries, in which the heat-resistant granular base material is hardened with the aid of sodium silicate or potassium silicate according to claim 4, characterized in that the chemical composition of the granular base material used for making the lining with a horizontal dividing plane that is considered to mark the top level of the molten iron or steel and the bottom level of the slag floating on the metal in the usual casting ladles or pouring boxes is chosen in such a way that the finished lining in this part of the casting ladle or pouring box has a lower total MgO content than the MgQ content above this level, while the chemical composition of the base material in the parts of the lining that lie above this level and is mostly expected to come into contact with the slag has a MgO content of at least 45%.

12. Process according to claim 2, characterized in that the silica component is used as a “dry waterglass”, which is added as a powder to the moist base material.

13. Process according to claim 3, characterized in that the silica component is used as a “dry waterglass”, which is added as a powder to the moist base material.

14. Process according to claim 4, characterized in that the silica component is used as a “dry waterglass”, which is added as a powder to the moist base material.

15. Process according to claim 5, characterized in that the silica component is used as a “dry waterglass”, which is added as a powder to the moist base material.

16. Wear lining for casting ladles and pouring boxes used in foundry practice, prepared by the process described in claim 2.

17. Wear lining for casting ladles and pouring boxes used in foundry practice, prepared by the process described in claim 3.

18. Wear lining for casting ladles and pouring boxes used in foundry practice, prepared by the process described in claim 4.

19. Wear lining for casting ladles and pouring boxes used in foundry practice, prepared by the process described in claim 5.

20. Wear lining for casting ladles and pouring boxes used in foundry practice, prepared by the process described in claim 6.
